(19) United States
(12) Patent Application Publication
(10) Pub. No.: US 2012/0192080 A1
(43) Pub. Date: Jul. 26, 2012

(54) TAILORING CONTENT BASED ON AVAILABLE BANDWIDTH

(75) Inventor: Matthew Lloyd, Cambridge, MA (US)

(73) Assignee: GOOGLE INC., Mountain View, CA (US)

(21) Appl. No.: 13/011,292

(22) Filed: Jan. 21, 2011

(51) Int. Cl. G06F 3/00

(52) U.S. Cl. 715/744

(57) ABSTRACT

A system is configured to: store contents of a web page; determine an estimate of available bandwidth for a page load for the web page; select one or more of the contents for the page load in response to a browser request from a browser; modify the selected contents based on the estimate of available bandwidth to produce modified contents of the web page; and transmit a part of the modified contents to the browser.

### BACKGROUND

Users are increasingly utilizing World Wide Web (“web”) browsers to access a growing variety of web services (e.g., e-mail, news websites, video-sharing websites, e-commerce websites, etc.) via the Internet. Bandwidth is the rate at which a web browser downloads data from or uploads data to a server associated with a web service. The amount of bandwidth available varies substantially based on a type of internet connection (e.g., dial-up internet access, cable Internet, Fiber Optic Service (FiOS), Wi-Fi connection, 3G, EDGE, etc.) used to access the web service. However, web services provide the same content regardless of the amount of bandwidth that is available. As a result, the experience of users with slow Internet connections (i.e., with low amount of available bandwidth) often decrease when web services provide content, to these users, which is designed for users with fast Internet connections (high amount of available bandwidth). In turn, web services are often forced to only provide content that is suitable for users with all (or most) types of Internet connections, including users with slow Internet connections. Accordingly, these web services sacrifice the ability to provide the greatest possible experience (e.g., by providing more content and/or higher quality content) to users with faster Internet connections.

More recently, some web services have begun to provide alternative content (“mobile versions”) for web sites, etc. to mobile device browsers (browsers that are designed for use on a mobile device, such as a mobile phone or a personal digital assistant (PDA)). User agent strings of mobile device browsers are used to signal to a web service that a browser request (e.g., a Hypertext Transfer Protocol (HTTP) request) is from a mobile device browser. Web services may now provide a “mobile version” of a website to a mobile browser of a mobile device and a “full version” of the website to all other types of browsers. Yet, a type of a browser may often provide incomplete (or incorrect) information to determine what type/amount of content the browser may receive/handle to provide a user with the best possible experience. For example, a mobile device with a mobile browser may be connected to a high-bandwidth WiFi connection that would allow a user to successfully experience a full version of a website. Alternatively, for example, a laptop may be connected to a low-bandwidth dial-up connection that makes receiving content for a full version of a website intolerable. Overall, merely providing an extra “mobile version” does not take into account the different Internet connections (or the numerous variations of the bandwidth) that may actually be used with a browser.

### SUMMARY

According to one aspect, a method may include: receiving, by a client device, input for a browser; determining, by the client device, an estimate of available bandwidth for the input; generating, by the client device, a browser request based on the input and the estimate of available bandwidth; transmitting, by the client device, the browser request to a server device; receiving, by the client device and in response to the browser request, modified contents from the server device; and presenting, by the client device, the modified contents in a user interface of the browser. The modified contents may be based on the estimate of available bandwidth.

According to another aspect, a method may include: receiving, by a server device, a browser request from a client device; identifying, by the server device, a web page specified by the browser request; determining, by the server device, an estimate of available bandwidth based on the browser request; tailoring, by the server device, the web page based on the estimate of available bandwidth; and transmitting, by the server device, contents associated with the tailored web page to the client device.

According to another aspect, a server device may include a memory and a processor. The memory may store contents of a web page. The processor may determine an estimate of available bandwidth for a page load for the web page; select one or more of the contents for the page load in response to a browser request from a browser; modify the selected contents based on the estimate of available bandwidth to produce modified contents of the web page; and transmit a part of the modified contents to the browser.

According to yet another aspect, a computer-readable medium, that includes instructions executable by one or more processors, may include one or more instructions to receive a browser request from a web browser, where the browser request identifies a web page of a website; determine an estimate of available bandwidth, for the web page, based on the browser request; retrieve a version of the web page based on the estimate of available bandwidth; and transmit packets, based on contents of the version of the page, to the web browser.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 is a diagram illustrating an overview of an example implementation described herein;

FIG. 2 is a diagram of an example environment in which systems and/or methods described herein may be implemented;

FIG. 3 is a diagram of example components of a client or server;

FIG. 4 is a flowchart illustrating an example process for receiving content based on an estimate of available bandwidth;

FIG. 5 is a flowchart illustrating an example process for calculating an estimate of available bandwidth;

FIG. 6 is a flowchart illustrating an example process for providing content based on an estimate of available bandwidth;

FIG. 7 is a diagram illustrating examples of browser requests; and

FIG. 8 is a diagram that illustrates an example of providing tailored content based on available bandwidth.

### DETAILED DESCRIPTION

The following detailed description refers to the accompanying drawings. The same reference numbers in different drawings may identify the same or similar elements.

Currently, when same content is provided by a web service to web browsers regardless of the different amounts of available bandwidths associated with the web browsers, users' Internet browsing experiences often suffer significantly. In an implementation, described herein, a browser or a web server that provides a website may calculate an estimate of available bandwidth for the browser. The device may send a browser request to the web server. The web server may tailor content for a web page of the website, in response to the browser request, based on the estimate of available bandwidth. The web server may provide the tailored content to the device. Herein, “content” may refer to “data,” “element,” “component,” “widget,” “image,” “video,” “audio,” or other parts of a web page.

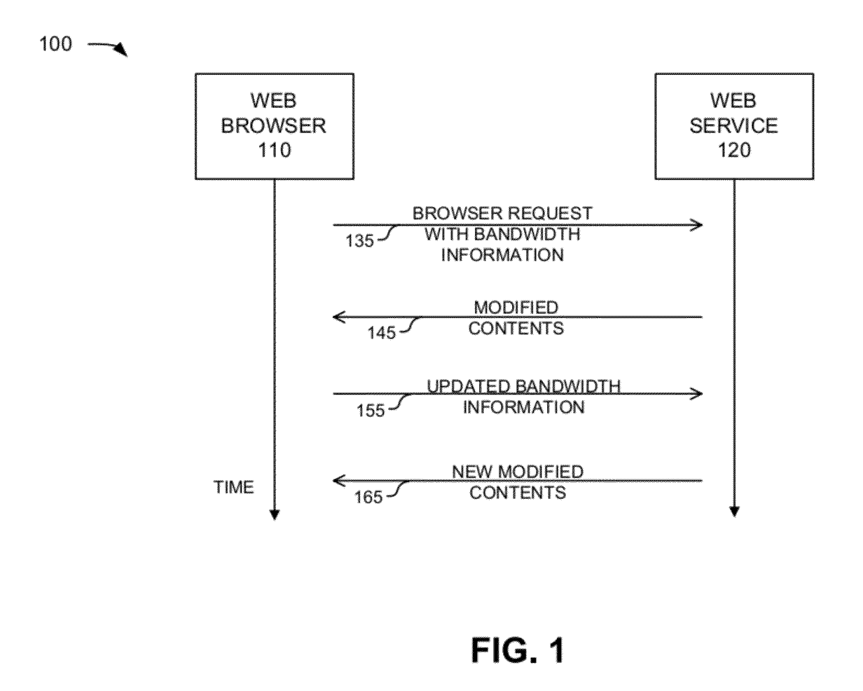

FIG. 1 is a diagram illustrating an overview 100 of an example implementation described herein. Assume that a user uses a web browser 110 to open a user interface (e.g., window, tab, etc.) of web browser 110 and to request content for a web page, from a web service 120, to display in the user interface. The user may open the web page by, for example, opening a window of web browser 110 or opening a new tab in an already-opened window of web browser 110. The user may request content by, for example, inputting a Uniform Resource Identifier (URI) (e.g., Uniform Resource Locator (URL), such as “www.example.com”) into web browser 110.

In one implementation, web browser 110 may calculate an estimate of bandwidth available for a page load corresponding to the web page (herein, “the estimate of available bandwidth”). Web browser 110 may generate a browser request with bandwidth information 135 (herein, “browser request 135”) to request the content from web service 120. Browser request 135 may include the estimate of available bandwidth. Web browser 110 may transmit browser request 135 to web service 120. In another implementation, web service 120 may calculate the estimate of available bandwidth (and browser request 135 may or may not include any bandwidth information).

Web service 120 may receive browser request 135 from web browser 110. Web service 120 may execute a tailoring process to retrieve, select, and/or modify contents, to satisfy browser request 135, based on the estimate of available bandwidth. The tailoring process may produce modified contents 145. Web service 120 may transmit modified contents 145 to web browser 110 after and/or during the tailoring process. In one implementation, at a later point in time, web browser 110 may calculate a new estimate of available bandwidth for the page load associated with the web page. Web browser 110 may include the new estimate in updated bandwidth information 155. Web browser 110 may transmit updated bandwidth information 155 to web service 120 as part of a new browser request or as part of any other type of message. Web service 120 may receive updated bandwidth information 155 from web browser 110. In another implementation, web service 120 may generate updated bandwidth information 155 on its own by performing its own calculations.

Web service 120 may adjust the ongoing tailoring process or start a new tailoring process based on updated bandwidth information 155. Thereafter, web service 120 may generate new modified contents 165 by taking into account any changes in bandwidth available to web browser 110 that occurred since receiving browser request 135. For example, if the available bandwidth decreased, new modified contents 165 may require less bandwidth than modified contents 145 for the user to properly experience the website of web service 120. Web service 120 may transmit new modified contents 165 to web browser 110.

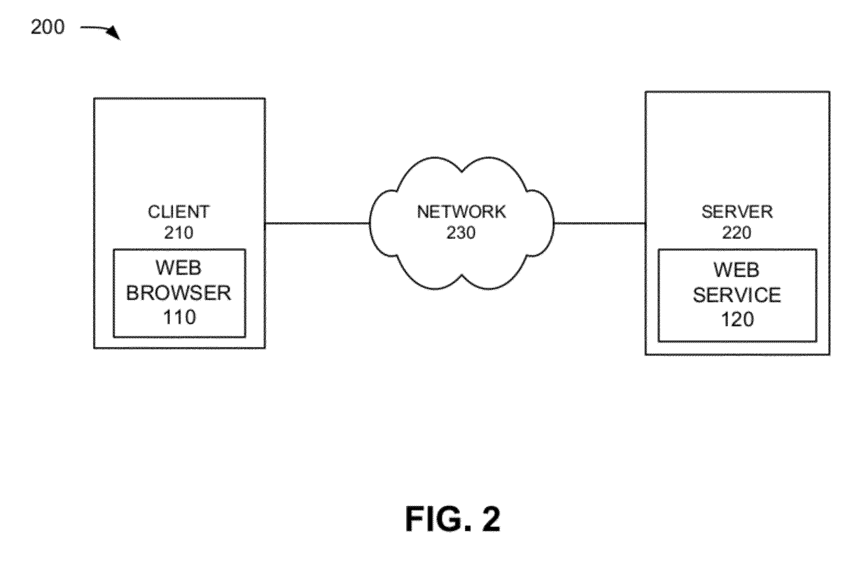

FIG. 2 is a diagram of an example environment 200 in which systems and/or methods described herein may be implemented. Environment 200 may include a client 210, a server 220, and a network 230. Client 210 may connect to server 220 via network 230. In practice, there may be multiple clients 210, multiple servers 220, and/or multiple networks 230. Also, in some instances, client 210 may perform a function of server 220, and server 220 may perform a function of client 210.

Client 210 may include a device, such as a personal computer, a wireless telephone, a PDA, a laptop, or another type of computation or communication device. In one implementation, client 210 may provide web browser 110 that permits a user to request and receive contents from web service 120. A display of client 210 may display a user interface (e.g., windows and/or tabs) for web browser 110. Client 210 may include special modifications for web browser 110 to allow web browser 110 to receive contents, from server 220, that is tailored based on an estimate of available bandwidth.

Client 210 may also store a local memory, such as database (DB) (e.g., SQLite DB), to store information for use by various methods described herein. For example, the local memory may store information about previous connections to the Internet (e.g., network 230) by web browser 110. The local memory, or another storage device, may also store information about tabs and/or windows of web browser 110 that are currently open (e.g., a counter of a quantity of web pages that are currently active (contents are loading (downloading or uploading) for the web pages), a list of the web pages with corresponding states of the web pages, etc.). Web browser 110 may access and use the information stored in the local memory, for example, to calculate and/or recalculate the estimate of available bandwidth.

Server 220 may include one or more server devices that implements web service 120 in a manner described herein. In one implementation, server 220 may host a website. Server 220 may provide tailored contents to client 210 in response to receiving browser requests from client 210. Server 220 may provide tailored contents to multiple clients, including client 210, at one time. Also, multiple servers may perform the same function(s) as server 210.

Server 220 may represent one or more servers that perform one or more of the functions of server 220. For example, server 220 may include a front-end server, a tailoring server, a contents storage server, a compression server, etc. The aforementioned servers may connect directly with each other, through network 230, or through one or more other networks. The front-end server may receive a browser request from client 210 and transmit tailored contents, in response to the browser request, to client 210. The tailoring server may identify, select, retrieve, and/or compile contents to satisfy the browser request based on the bandwidth information included in the browser request. The contents storage server may represent one or more memory devices. The contents storage server may store contents, including different versions/types of the same contents, that are suitable to be received by web browsers with different available bandwidths. The compression server may modify the contents stored on the contents storage server. For example, the compression server may further reduce the size of the contents based on the available bandwidth of web browser 110. One or more of the aforementioned servers may be implemented as two or more separate (and possibly distributed) servers.

Network 230 may include a single network, multiple networks of a same type, or multiple networks of different types. For example, network 230 may include a local area network (LAN), a wide area network (WAN) (e.g., the Internet), a metropolitan area network (MAN), a wireless network (e.g., a general packet radio service (GPRS) network), a telephone network (e.g., a Public Switched Telephone Network), a cellular network (e.g., 3G network, 4G network, etc.), a subset of the Internet, an ad hoc network, a fiber optic network (e.g., a fiber optic service (FiOS) network), or any combination of the aforementioned networks. Client 210 and server 220 may connect to network 230 via wired and/or wireless connections.

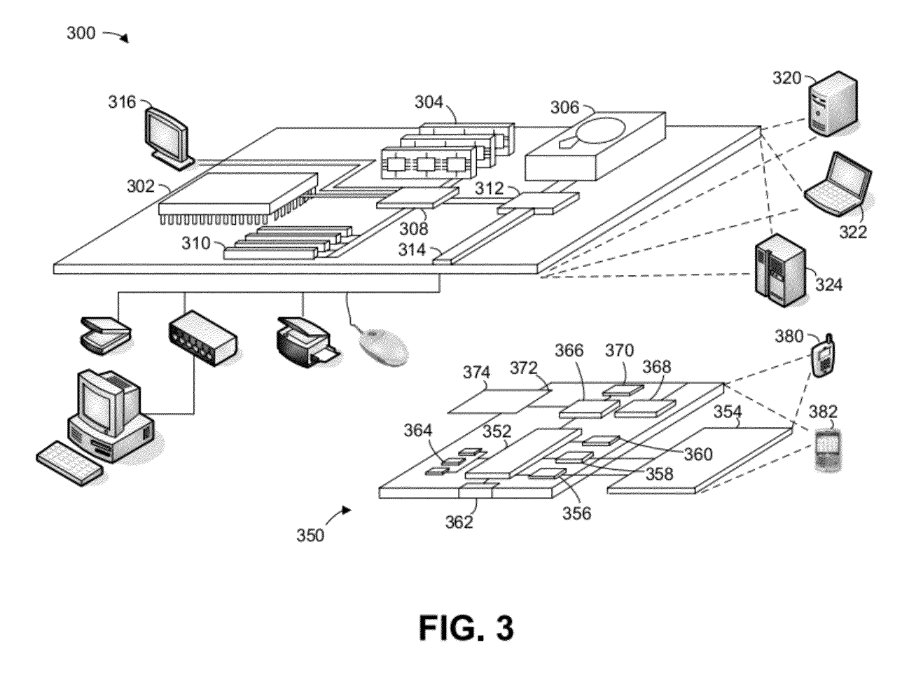

FIG. 3 shows an example of a generic computing device 300 and a generic mobile computing device 350, which may be used with the techniques described herein. Computer device 300 or mobile computing device 350 may correspond to, for example, client 210 and/or server 220. Computing device 300 is intended to represent various forms of digital computers, such as laptops, desktops, workstations, personal digital assistants, servers, blade servers, mainframes, and other appropriate computers. Mobile computing device 350 is intended to represent various forms of mobile devices, such as personal digital assistants, cellular telephones, smart phones, and other similar computing devices. The components shown in FIG. 3, their connections and relationships, and their functions, are meant to be exemplary only, and are not meant to limit implementations of the inventions described and/or claimed in this document.

Computing device 300 includes a processor 302, memory 304, a storage device 306, a high-speed interface 308 connecting to memory 304 and high-speed expansion ports 310, and a low speed interface 312 connecting to low speed bus 314 and storage device 306. Each of the components 302, 304, 306, 308, 310, and 312, are interconnected using various busses, and may be mounted on a common motherboard or in other manners as appropriate. The processor 302 can process instructions for execution within the computing device 300, including instructions stored in the memory 304 or on the storage device 306 to display graphical information for a graphical user interface (GUI) on an external input/output device, such as display 316 coupled to high speed interface 308. In other implementations, multiple processors and/or multiple buses may be used, as appropriate, along with multiple memories and types of memory. Also, multiple computing devices 300 may be connected, with each device providing portions of the necessary operations (e.g., as a server bank, a group of blade servers, or a multi-processor system, etc.).

The memory 304 stores information within the computing device 300. In one implementation, the memory 304 includes a volatile memory unit or units. In another implementation, the memory 304 includes a non-volatile memory unit or units. The memory 304 may also be another form of computer-readable medium, such as a magnetic or optical disk.

The storage device 306 is capable of providing mass storage for the computing device 300. In one implementation, the storage device 306 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer or machine-readable medium, such as the memory 304, the storage device 306, or memory on processor 302.

The high speed controller 308 manages bandwidth-intensive operations for the computing device 300, while the low speed controller 312 manages lower bandwidth-intensive operations. Such allocation of functions is exemplary only. In one implementation, the high-speed controller 308 is coupled to memory 304, display 316 (e.g., through a graphics processor or accelerator), and to high-speed expansion ports 310, which may accept various expansion cards (not shown). In one implementation, low-speed controller 312 is coupled to storage device 306 and low-speed expansion port 314. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 320, or multiple times in a group of such servers. It may also be implemented as part of a rack server system 324. In addition, it may be implemented in a personal computer, such as a laptop computer 322. Alternatively, components from computing device 300 may be combined with other components in a mobile device (not shown), such as mobile computing device 350. Each of such devices may contain one or more of computing device 300 or mobile computing device 350, and an entire system may be made up of multiple computing devices 300, 350 communicating with each other.

Mobile computing device 350 includes a processor 352, memory 364, an input/output (I/O) device such as a display 354, a communication interface 366, and a transceiver 368, among other components. Mobile computing device 350 may also be provided with a storage device, such as a micro-drive or other device, to provide additional storage. Each of the components 350, 352, 364, 354, 366, and 368, are interconnected using various buses, and several of the components may be mounted on a common motherboard or in other manners as appropriate.

Processor 352 can execute instructions within the mobile computing device 350, including instructions stored in the memory 364. Processor 352 may be implemented as a chipset of chips that include separate and multiple analog and digital processors. Processor 352 may provide, for example, for coordination of the other components of the device 350, such as control of user interfaces, applications run by mobile computing device 350, and wireless communication by mobile computing device 350.

Processor 352 may communicate with a user through control interface 358 and display interface 356 coupled to a display 354. The display 354 may be, for example, a TFT LCD (Thin-Film-Transistor Liquid Crystal Display) or an OLED (Organic Light Emitting Diode) display, or other appropriate display technology. The display interface 356 may comprise appropriate circuitry for driving the display 354 to present graphical and other information to a user. The control interface 358 may receive commands from a user and convert them for submission to the processor 352. In addition, an external interface 362 may be provide in communication with processor 352, so as to enable near area communication of mobile computing device 350 with other devices. External interface 362 may provide, for example, for wired communication in some implementations, or for wireless communication in other implementations, and multiple interfaces may also be used.

The memory 364 stores information within the mobile computing device 350. The memory 364 can be implemented as one or more of a computer-readable medium or media, a volatile memory unit or units, or a non-volatile memory unit or units. Expansion memory 374 may also be provided and connected to mobile computing device 350 through expansion interface 372, which may include, for example, a SIMM (Single In Line Memory Module) card interface. Such expansion memory 374 may provide extra storage space for mobile computing device 350, or may also store applications or other information for mobile computing device 350. Specifically, expansion memory 374 may include instructions to carry out or supplement the processes described above, and may include secure information also. Thus, for example, expansion memory 374 may be provide as a security module for mobile computing device 350, and may be programmed with instructions that permit secure use of mobile computing device 350. In addition, secure applications may be provided via the SIMM cards, along with additional information, such as placing identifying information on the SIMM card in a non-hackable manner.

The expansion memory 374 may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 364, expansion memory 374, or memory on processor 352, that may be received, for example, over transceiver 368 or external interface 362.

Mobile computing device 350 may communicate wirelessly through communication interface 366, which may include digital signal processing circuitry where necessary. Communication interface 366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 368. In addition, short-range communication may occur, such as using a Bluetooth, WiFi, or other such transceiver (not shown). In addition, GPS (Global Positioning System) receiver module 370 may provide additional navigation- and location-related wireless data to mobile computing device 350, which may be used as appropriate by applications running on mobile computing device 350.

Mobile computing device 350 may also communicate audibly using audio codec 360, which may receive spoken information from a user and convert it to usable digital information. Audio codec 360 may likewise generate audible sound for a user, such as through a speaker, e.g., in a handset of mobile computing device 350. Such sound may include sound from voice telephone calls, may include recorded sound (e.g., voice messages, music files, etc.) and may also include sound generated by applications operating on mobile computing device 350.

Mobile computing device 350 may be implemented in a number of different forms, as shown in the figure. For example, it may be implemented as a cellular telephone 380. It may also be implemented as part of a smart phone 382, personal digital assistant, or other similar mobile device.

Computing device 300, mobile computing device 350, and/or another device may perform certain operations, as described in detail below. Computing device 300, mobile computing device 350, and/or the another device may perform these operations in response to a processor executing software instructions (e.g., computer program(s)) contained in a computer-readable medium, a secondary storage device (e.g., hard disk, CD-ROM, etc.), or other forms of RAM or ROM. A computer-readable medium may be defined as a non-transitory memory device. A memory device may include memory space within a single physical memory device or spread across multiple physical memory devices. Alternatively, hardwired circuitry may be used in place of or in combination with software instructions to implement processes described herein. Thus, implementations described herein are not limited to any specific combination of hardware circuitry and software.

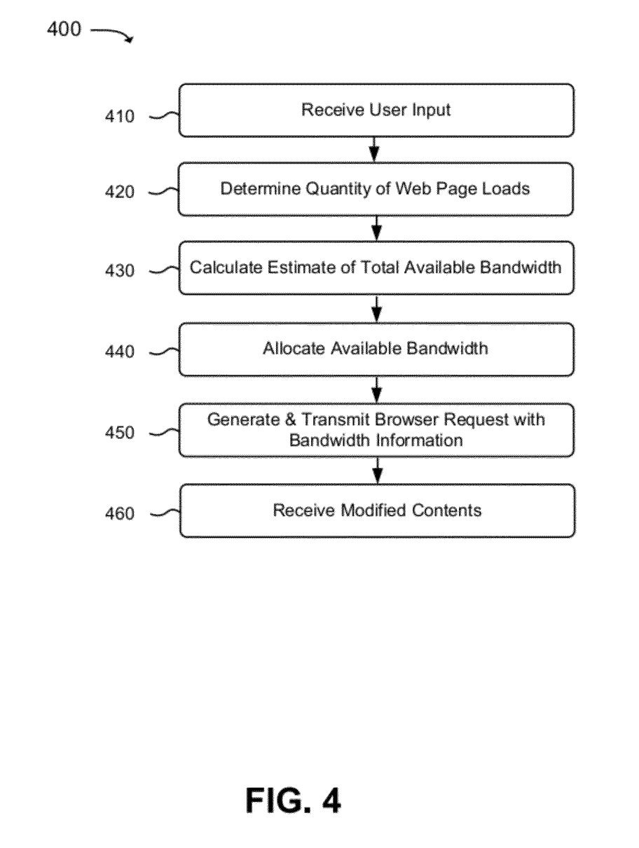

FIG. 4 is a flowchart illustrating an example process 400 for receiving contents based on an estimate of available bandwidth. In one implementation, web browser 110 of client 210 may perform process 400. In other implementations, one or more software application(s) (e.g., an operating system (OS) (e.g., Chrome OS)) of client 210 and/or of one or more other devices may perform some or all of process 400 separate from, or in combination with, web browser 110 of client 210.

As shown in FIG. 4, process 400 may include receiving user input (block 410). For example, a user may open a new window or a new tab of web browser 110. The user may provide user input by entering a URI (e.g., www.example.com) into web browser 110. The user input may prompt web browser 110 to request contents for a web page (e.g., an index/a home page) of a website corresponding to the URI. In another example, the user may provide user input by entering a selection (e.g., selecting a link, selecting a bookmark, selecting to play a video, entering commands to initiate and/or complete a transaction, etc.) into a web page of a website already open in web browser 110. The user input may prompt web browser 110 to request a new web page (e.g., a subpage of a website) and/or additional contents (e.g., video stream) to satisfy the selection. In yet another example, the user may provide user input by prompting web browser 110 to open an additional tab or window to display another web page in the additional tab/window. The user input may prompt web browser 110 to retrieve/request contents for the web page.

A quantity of web page loads may be determined (block 420). In one implementation, web browser 110 may maintain a counter of a quantity of web pages that are loading (i.e., (web) page loads). Here, the web pages that are loading correspond to page loads. Web browser 110 may increase a counter each time that a process begins (e.g., when a user provides user input in block 410, when a web page refreshes its contents, etc.) for loading contents for a web page. Web browser 110 may decrease the counter when the process ends (e.g., the loading of the contents for the web page is complete, the user closes a window/tab with the web page, etc.). In another implementation, web browser 110 may maintain a list of web pages that are active in windows and/or tabs of web browser 110. Web browser 110 may determine the quantity of web pages that are loading based on the list by determining what active windows and/or tabs are associated with current downloading and/or uploading contents for web pages. In yet another implementation, an operating system (OS) (e.g., Chrome OS) of client 210 may maintain a counter and/or list of active web pages that are loading on web browser 110 and/or one or more other (different) web browsers that are operating on client 210. Web browser 110 may receive a value of the quantity of web pages that are loading from the OS.

In other implementations, web browser 110 or the OS of client 210 may determine the quantity of web pages that are loading before beginning a process for calculating an estimate of total available bandwidth. Web browser 110 or the OS of client 210 may receive information to calculate the quantity of web pages that are loading from web browser 110 and/or one or more other web browsers that are operating on client 210. In yet other implementations, web browser 110, the OS of client 210, or another application and/or OS of a device (e.g., a router, gateway, or modem) that is directly connected to client 210 may determine the quantity of web pages that are loading by web browsers operating on client 210 and by one or more other web browsers that share an Internet connection to network 230 with client 210.

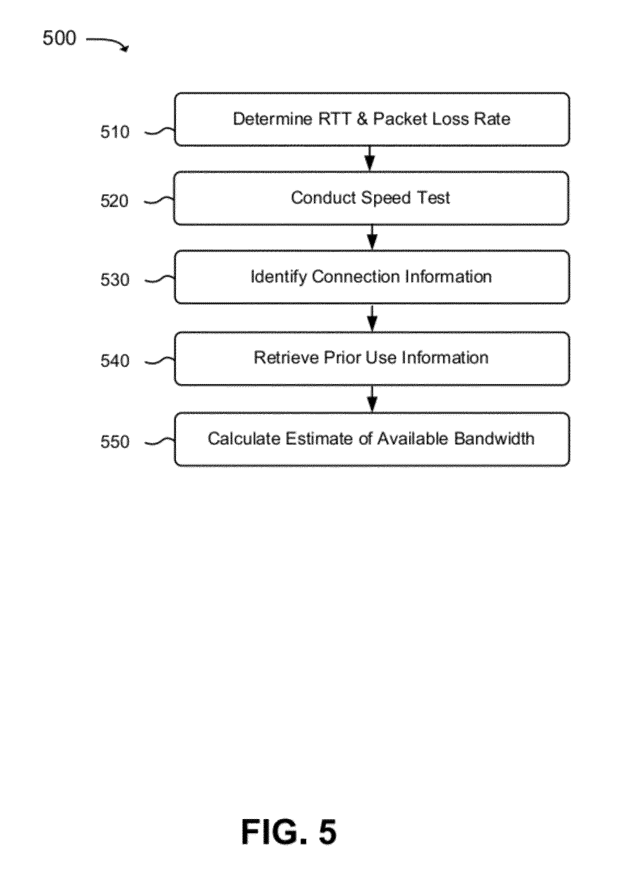

An estimate of total available bandwidth may be calculated (block 430). For example, web browser 110 may use one or more algorithms of a calculating process, as described below in reference to FIG. 5, to calculate the estimate of total available bandwidth. In another implementation, client 110 or an external server may maintain a table (e.g., DB) that provides estimates of available bandwidths based on a connection type (e.g., FiOS, 3G) or a current geographic location (e.g., a name of a country (e.g., USA), a city (e.g., Baghdad), a zip code (e.g., 07039), geographic coordinates, etc.), and/or a time of day or day of the week. Web browser 110 may determine the estimate of total available bandwidth by referencing the table based on a type of network connection that is currently connecting client 210 to network 230, the current geographic location of client 210, and/or the current time of day or day of the week. In yet another implementation, web browser 110 may calculate/determine different estimates of total available bandwidth for different types of bandwidths. For example, web browser 110 may calculate/determine an estimate of total available download bandwidth and an estimate of total available upload bandwidth. Herein, any reference to “bandwidth” may refer to “download bandwidth” and/or “upload bandwidth.”

Available bandwidth may be allocated (block 440). For example, web browser 110 may allocate equal amounts (parts) of the estimate of total available bandwidth to each web page that is loading. To do so, web browser 110 may divide the estimate of total available bandwidth (e.g., 20 Megabytes per second (Mbps)) by the quantity of web pages loads (e.g., 5). Web browser 110 may allocate a quotient (e.g., 4 Mbps) of the division to each one of the web page loads. In other implementations, web browser 110 may allocate different amounts of the estimate of total available bandwidth to different web page loads based on a variety of factors, including states of the web pages, types of the web pages, preferences set by a user, etc. For example, web browser 110 may allocate a greater amount (e.g., 7 Mbps) of the estimate of total available bandwidth to a web page that is loading in a tab and/or a window that is currently open and/or being displayed on a display of client 210. Simultaneously, web browser 110 may allocate a lesser amount (e.g., 0.5 Mbps) of the estimate of total available bandwidth to a web page that is loading in a tab and/or a window that is hidden/minimized. In another example, web browser 110 may allocate a greater amount of the estimate of total available bandwidth to web page loads that requires higher bandwidth to improve the user's experience (e.g., a web page that provides video contents (e.g., www.youtube.com)) in contrast to other web page loads that do not require higher bandwidth to maximize the user's experience (e.g., a text-based web page (e.g., www.drudgereport.com)). In yet another example, the user may set a variety of preferences regarding how web browser 110 should allocate the estimate of total available bandwidth to various web page loads (e.g., a preference may be set to provide half of the amount of the estimate of total available bandwidth to web page loads corresponding to a particular website). Herein, any reference to “estimate of available bandwidth” may refer to an amount of the estimate of total available bandwidth that is allocated to a single web page load.

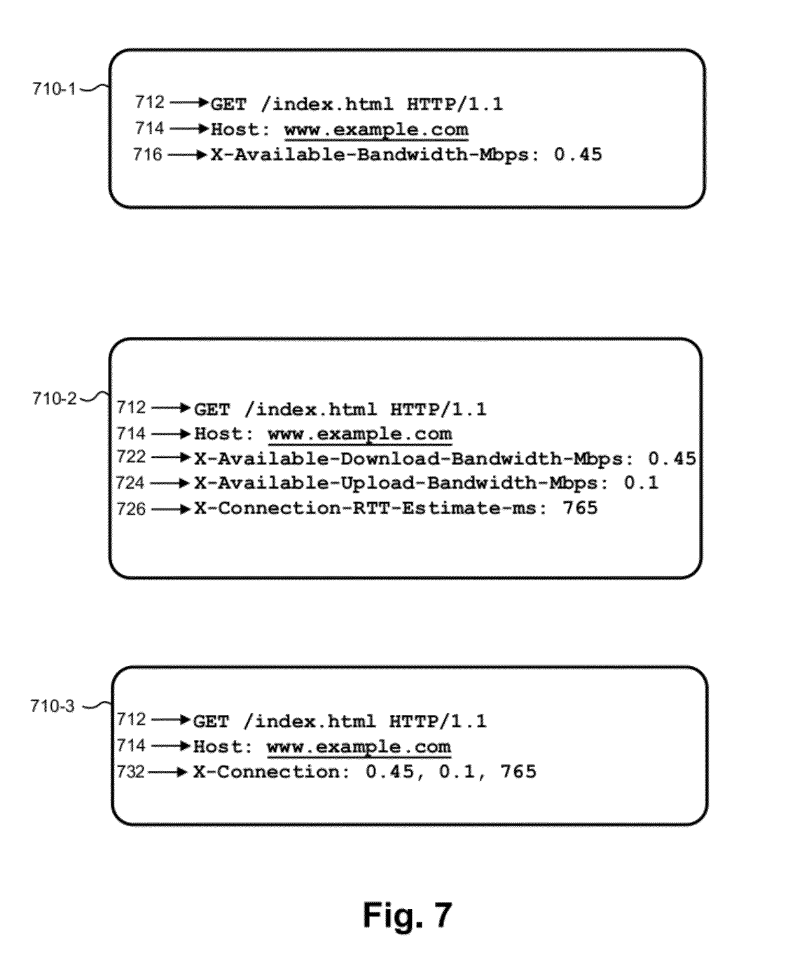

A browser request with bandwidth information may be generated and transmitted (block 450). For example, after web browser 110 receives user input (block 410), web browser 110 may initiate a process to retrieve contents for a web page, from web service 120, based on the user input. To do so, web browser 110 may generate the browser request (e.g., HTTP request). Examples of browser requests are described below in reference to FIG. 7. The browser request may include instructions (e.g., “GET” to receive contents for a web page), an identifier of a web page (e.g., “index.html” for a home page) of a website, and a URI (e.g., www.example.com) to identify a host (e.g., server 220) of web service 120. The browser request may also include headers (e.g., “X-Available-Bandwidth”) to include bandwidth information. The bandwidth information may include an amount of the estimate of total available bandwidth (e.g., 0.1 Mbps) that is allocated for a web page load corresponding to the browser request. Client 210 may transmit the browser request to server 220 via network 230.

Modified contents may be received (block 460). For example, server 220 may receive the browser request from client 210. Web service 120, which is associated with server 220, may execute a tailoring process to retrieve, select, compress, and/or modify contents, to satisfy the browser request, based on the bandwidth information included in the browser request. The tailoring process may produce the modified contents. Web service 120 may transmit the modified contents to client 210. Web browser 110 may display a web page in a user interface of web browser 110 based on the modified contents.

In another implementation, web browser 110 may provide feedback to the user of web browser 110 to improve the user's web browsing experience. For example, web browser 110 may determine that web service 120 does not tailor pages/contents (i.e., does not provide modified contents) based on the estimate of total available bandwidth. Web browser 110 may notify the user that web service 120 does not tailor pages/contents. In response, the user may select to terminate a web page load (e.g., by closing a tab or a window) associated with web service 120. In another example, web browser 110 may determine that the user's web browsing experience is being impeded by the user's action(s) (e.g., the user initiated too many web page loads, which is decreasing the amount of the estimate of total available bandwidth that is allocated to each one of the web page loads). Web browser 110 may notify the user regarding what the user's action(s) are that are impeding the user's web browsing experience and/or how the user may improve the user's web browsing experience (e.g., web browser 110 may advise the user to close one or more tabs/windows of web browser 110 to terminate one or more of the web page loads).

In yet another example, web browser 110 may allow the user to set bandwidth allocation preferences, as described above, and/or override determinations regarding what contents are provided to web browser 110 in response to user input. Assume that web browser 110 calculates a low amount for the estimate of total available bandwidth and transmits a browser request for a web page to web service 120. In response to the browser request, web service 120 may retrieve a version (e.g., contents for the version) of the web page that is suited for low available bandwidth. Web browser 110 may provide a user with the option to retrieve a normal (e.g., full) version of the web page regardless of the estimate of total available bandwidth. The user may select the normal version of the web page when, for example, a user prefers the normal version of the page and is willing to tolerate slow download of contents for the page. Similarly, a user may select to download a version (e.g., contents for the version) of a web page that is suitable (predefined) for lower bandwidth than the current estimate of available bandwidth.

FIG. 5 is a flowchart illustrating an example calculating process 500 for calculating an estimate of available bandwidth. In one implementation, web browser 110 of client 210 may perform process 500. In other implementations, one or more software application(s) (e.g., an operating system (OS) (e.g., Chrome OS)) of client 210 and/or of one or more other devices may perform some or all of process 500 separate from, or in combination with, web browser 110 of client 210. Process 500 may correspond to block 430 in FIG. 4.

In one implementation, calculating process 500 may begin after a user opens any tab and/or window of web browser 110. In another implementation, calculating process 500 may begin after web browser 110 receives a first input (e.g., at block 410 of FIG. 4) and/or when web browser 110 begins to generate a first browser request. Calculating process 500 may repeat periodically until a user exits web browser 110.

In yet another implementation, process 500 may occur at an OS (e.g., Chrome OS) level of client 210. Therefore, calculating process 500 may begin after client 210 is powered-on and repeat periodically until client 210 is powered-off.

As shown in FIG. 5, process 500 may include determining a round-trip-time (RTT) and a packet loss rate (block 510). For example, web browser 110 may prompt client 210 to transmit Internet Control Message Protocol (ICMP) echo request packets (herein, “ICMP echo packets”) to server 220 and wait for ICMP responses. Client 210 may measure an average time from transmission of the ICMP echo packets to reception of the ICMP responses to determine the RTT. Client may also determine how many fewer ICMP responses were received than a quantity of the ICMP echo packets that were sent to determine the packet loss rate. In one implementation, web browser 110 may calculate/determine a first estimate of available bandwidth based on the RTT and/or the packet loss rate by using a regression model. The regression model may model a relationship between RTTs and/or packet loss rates and estimates of available bandwidths.

A speed test may be conducted (block 520). For example, web browser 110 may conduct the speed test to directly measure the available bandwidth. To do so, web browser 110 may download a test file (e.g., a small file) from (or upload the test file to) a predetermined host that is known to have a particular fast connection (greater than a particular speed) (e.g., a www.google.com server (e.g., server 120)). Web browser 110 may measure various statistics related to the downloading of the test file (or uploading of the test file), including an amount of time taken to download/upload the test file, a peak transfer rate during the downloading/uploading, etc. Web browser 110 may calculate a second estimate of available bandwidth based on one or more of the measured statistics.

Connection information may be identified (block 530). For example, an OS of client 210 may store connection information about a current network connection of client 210 to network 230 (e.g., the Internet). The connection information may include, for example, one or more pieces of data/factors to indicate whether the current network connection is wired or wireless; a service set identifier (SSID) of the current network connection when the current network connection is wireless; a type of a modem used to establish the current network connection; a status of the current network connection (when the network connection is, for example, 3G, EDGE, or dial-up), a client Internet Protocol (IP) address of client 210, a gateway IP address associated with a residential gateway (e.g., a router) that connects client 210 to the current network connection; a number of devices, including client 210, that are connected to a LAN associated with client 210; etc. The OS of client 210 may provide the connection information to web browser 110.

In another implementation, web browser 110 may derive one or more pieces of the connection information from Network Basic Input/Output System (NetBIOS) associated with client 210, Address Resolution Protocol (ARP) requests, broadcast packets, etc. Web browser 110 may use the connection information to make determinations about a type of the connection that client 210 is using to connect to network 230. In one implementation, web browser 110 may calculate a third estimate of available bandwidth by referencing a memory that provides relationships between various types of connections and corresponding estimates of available bandwidths. The memory may store information specific for client 210 (as described further below in reference to block 540), for a type of device of client 210, and/or for different types of devices and/or general information for different types of connections. In another implementation, web browser 110 may apply one or more algorithms to calculate the third estimate of available bandwidth based on various factors that make up the connection information.

Prior use information may be retrieved (block 540). For example, web browser 110 may store prior use information about prior connections by web browser 110. The prior use information may include various statistics, including, for example, for a single prior connection: a type of the connection, a RTT, a packet loss rate, prior bandwidth estimate(s) for the single connection, etc. Web browser 110 may retrieve the prior use information based on a current connection of client 210.

For example, client 210 may currently use a wireless 3G card to connect to network 230. In one implementation, web browser 110 may retrieve prior user information for when client 210 used the wireless 3G card to previously connect to network 230. In another implementation, web browser 110 may retrieve prior user information of previous connection(s) with characteristics that most closely match the current connection. Web browser 110 may determine a fourth estimate of available bandwidth based on the retrieved prior use information. In yet another implementation, web browser 110 may use the prior use information to generate/update models. In other implementations, a central server may receive data from a group of clients (e.g., including the prior use information from client 210) that are using various connection types, etc. The central server may create/train estimation models based on the data. The central server may provide the estimation models to web browser 110. Web browser 110 may use the models to calculate the fourth estimate of available bandwidth for the current connection.

An estimate of available bandwidth may be calculated (block 550). Process 500 may include one or more of blocks 510-540. Web browser 110 may perform blocks 510-540 in any order. One of blocks 510-540 may rely on one or more aspects (e.g., processes, calculations, data) of another one of blocks 510-540. In one implementation, process 500 may not actually calculate any estimate of available bandwidth until after one or more blocks 510-540 are complete. In another implementation, web browser 110 may use one or more of values calculated separately for the first estimate of available bandwidth, the second estimate of available bandwidth, the third estimate of available bandwidth, and/or the fourth estimate of available bandwidth to calculate another one of the aforementioned estimates of available bandwidth. In yet another implementation, web browser 110 may calculate an average/overall estimate of available bandwidth based on one or more of the first estimate of available bandwidth, the second estimate of available bandwidth, the third estimate of available bandwidth, and/or the fourth estimate of available bandwidth.

For example, web browser 110 may use averaging, weighted averaging, Bayes' theorem, and/or one or more other algorithm(s) to calculate the average/overall estimate of available bandwidth. In another example, web browser 110 may use Gaussian distribution that is based on prior estimates of available bandwidth (and/or prior use information). Web browser 110 may use the aforementioned different estimates of available bandwidth of the current connection to determine a posterior probability distribution based on the Gaussian distribution. Web browser 110 may use a mode or a mean of the posterior probability distribution as the overall estimate of available bandwidth of the current connection.

In other implementations, web browser 110 or web service 120 may determine other information and/or conduct other tests to determine the estimate of available bandwidth. The other information and/or the other tests may provide data related to one or more of: a link capacity of a network connection between client 210 and network 230 (e.g., the Internet), a degree of network congestions on the network connection, and/or a degree of network congestions on a path between client 210 to server 220 via network 230. Web service 120 may use the other information and/or the other tests in combination with, or instead of, some or all of process 500 to calculate the estimate of available bandwidth.

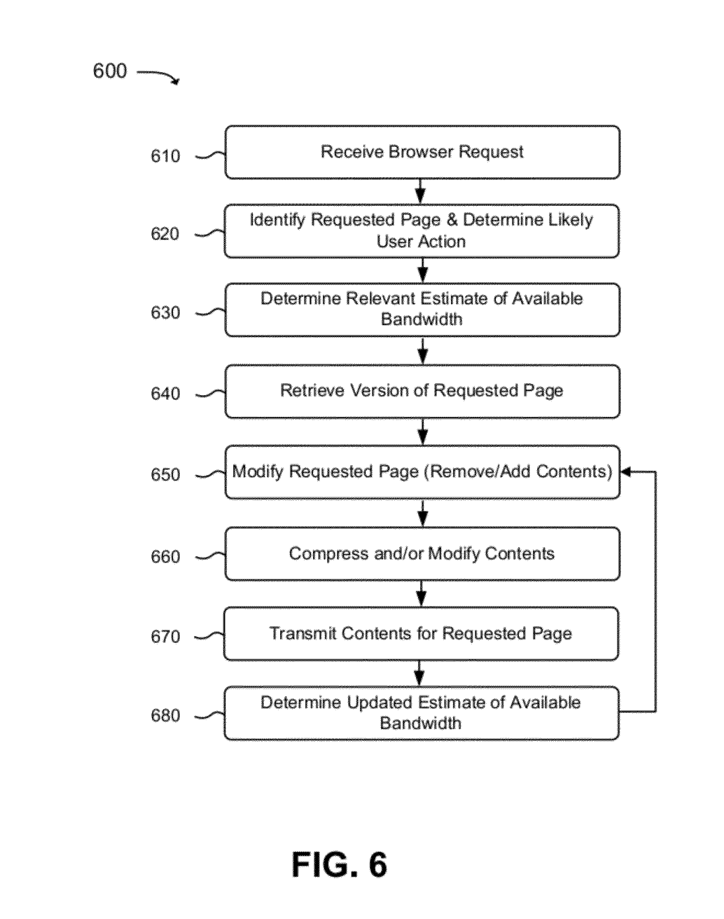

FIG. 6 is a flowchart illustrating an example process 600 for providing contents based on an estimate of available bandwidth. In one implementation, web service 120 of server 220 may perform process 600. In other implementations, a device or collection of devices separate from, or in combination with, server 220 may perform some or all of process 600. FIG. 6 is described below with references to FIG. 7. FIG. 7 is a diagram illustrating examples of browser requests, including a browser request 710-1, a browser request 710-2, and a browser request 710-3 (herein, referred to individually as “browser request 710”).

As shown in FIG. 6, process 600 may include receiving browser request 710 (block 610). For example, web browser 110 may receive user input associated with web service 120. A user may enter “www.example.com” as a URI into web browser 110. The URI (e.g., “www.example.com”) may identify a website that is provided by web service 120/hosted by server 220. Web browser 110 may generate browser request 710 based on the user input. As shown in FIG. 7, browser request 710 may include a line 714. Line 714 may specify the URI of the host (e.g., “Host: www.example.com”) that is supposed to receive browser request 710. Web browser 110 may transmit browser request 710 to web service 120 via network 230. Web service 120 may receive browser request 710.

A requested page may be identified and likely user action may be determined (block 620). For example, as shown in FIG. 7, browser request 710 may include a line 712. Line 712 may specify a version of a protocol (e.g., “HTTP/1.1”) that is being used. Web service 120 may determine that browser request 710 is an HTTP request based on line 712. Thereafter, web service 120 may proceed to retrieve contents to provide to web browser 110 in response to browser request 710. Line 712 may also specify what web page is being requested (e.g., “GET /index.html”) by browser request 710.

For example, web service 120 may identify, based on “GET /index.html” in browser request 710, that a home (index) page of website “www.example.com” is being requested. Web service 120 may determine that to satisfy browser request 710, web service 120 may need to provide contents for the home page that web browser 110 will need to download. Web service 120 may further determine likely user action(s) (browser requests) that may occur after the contents are downloaded based on current browser request 710. In one example, the home page of website “www.example.com” may provide links to download additional contents. As a result, web service 120 may determine that the likely user action includes prompting one or more additional browser requests, after browser request 710, to download the additional contents. In another example, the home page of website “www.example.com” may allow to upload contents (e.g., images, videos, etc.) to server 220 of web service 120. In this case, web service 120 may determine that the likely user actions may include uploading contents to web service 120.

A relevant estimate of available bandwidth may be determined (block 630). In one implementation, web service 120 may determine the relevant estimate of available bandwidth based on browser request 710. For example, browser request 710-1 may include a line 716. Line 716 may include a header (e.g., X-Available-Bandwidth-Mbps”) for providing the relevant estimate of available bandwidth that was calculated/determined by web browser 110 for actions involving download of contents from server 220 and/or upload of contents to server 220. Web service 120 may determine that the relevant estimate of available bandwidth for browser request 710-1 is “0.45.”

In another example, browser request 710-2 may include a download line 722, an upload line 724, and an RTT estimate line 726. Download line 722 may include a header (e.g., “X-Available-Download-Bandwidth-Mbps”) and a value (e.g., 0.45) for an estimate of available download bandwidth. Upload line 724 may include a header (e.g., “X-Available-Upload-Bandwidth-Mbps”) and a value (e.g., 0.1) for an estimate of available upload bandwidth. RTT estimate line 726 may include a header (e.g., “X-Connection-RTT-Estimate-ms”) and a value (e.g., 765) for an RTT estimate that was calculated by web browser 110. Browser request 710-2 may include one or more other lines, instead of or in addition to RTT estimate line 726, that provide other connection information (e.g., statistics) about a connection of client 210 to network 230. Web service 120 may use one or more of the download bandwidth, the upload bandwidth, and/or the other connection information provided in browser request 710-2 to determine the relevant estimate of available bandwidth based on a purpose of the requested web page. For example, web browser 110 may determine to use the upload bandwidth as the relevant estimate of available bandwidth when browser request 710-2 is to download a web page for (the purpose of which is) uploading videos. In other words, web browser 110 may use the identified requested page and the determined likely user action to determine the relevant estimate of available bandwidth.

In yet another example, browser request 710-3 may include a bandwidth information line 732. Bandwidth information line 732 may include a header (e.g., “X-Connection”), a download value (e.g., 0.45) for an estimate of available download bandwidth, an upload value (e.g., 0.1) for an estimate of available upload bandwidth, and one or more other values for statistics and/or information about a connection of client 210 to network 230 (e.g., value of 765 for an RTT estimate). Web browser 110 may use one or more of the values in bandwidth information line 732 of browser request 710-3 to determine the relevant estimate of available bandwidth, in a way similar to how the values are used above in reference to browser request 710-2.

In another implementation, web service 120 may determine the relevant estimate of available bandwidth without relying on any bandwidth-related estimates that are included in browser request 710. For example, web service 120 may determine an IP address associated with client 210 of web browser 110. Web service 120 may determine (e.g., retrieve from a different server) connection information and/or prior use information for client 210 based on the IP address. The connection information may include a type of network connection that connects client 210 to network 230, an Internet service (ISP) provider of the network connection, and/or a geographic location of client 210. The prior use information may include statistics, data, models, etc. related to previous connections that are associated with the IP address. Web service 120 may determine the relevant estimate of available bandwidth based on at least one of the connection information and/or the prior use information. Web service 120 may use one or more of the processes described above as being used by web browser 110 (e.g., in FIG. 5) to determine the relevant estimate of available bandwidth for web browser 110.

A version of the requested page may be retrieved (block 640). For example, web service 120 may store different versions of a single web page of a website. Web designers may design/tailor each one of the versions for a different amount of available bandwidth. For example, a high bandwidth version may include additional text, images, videos, and/or other contents than versions for lower bandwidth. Similarly, a low bandwidth version may include minimal contents and minimal options to minimize the amount of contents that may need to be downloaded and/or uploaded. One or more medium bandwidth versions may include combinations of one or more characteristics/contents of the high bandwidth version and/or of one or more characteristics/contents of the low bandwidth version. Web service 120 may select and retrieve one of the versions of the requested page based on which one of the versions is best suited for the relevant estimate of available bandwidth. For example, web service 120 may determine that the requested page is a page to upload video contents. Web service 120 may further determine that the relevant estimate of available bandwidth for web browser 110 is relatively low available upload bandwidth. Based on the requested page and the relevant estimate of available bandwidth, web service 120 may select and retrieve a version of the requested page that only displays contents to allow a user to upload low-resolution videos.

In one implementations, a web design application (and or an add-on for the web design application) may provide various tools to allow a web designer to create different versions of a web page. For example, the various tools may include one or more tools to calculate a total size of a created page, to estimate download times for the created page based on different network connections, and/or to simulate experiences of downloading the created page (and/or uploading contents while using the created page) when using the different network connections. The designer may modify (e.g., remove, substitute) contents from the created page to change (e.g., reduce) the total size, improve a download time, and/or improve a user experience for one of the versions of the web page. The various tools may further include one or more tools to modify the individual components (i.e., contents) of the web page (e.g., by compressing video contents, generating a low-resolution version of image contents, etc.) for different versions of the web page.

In other implementation, a web design application (and/or an add-on for the web design application) may allow to automatically generate one or more lower bandwidth versions of a web page based on a high bandwidth version of the web page. For example, a designer may create the high bandwidth version of the web page. The designer may label (e.g., by using HTML tag markups) one or more components of the high bandwidth version as core components and/or optional components. In another example, the designer may label components by assigning values (e.g., by providing priority levels) to the components based on a scale (e.g., scale of 1-10) of importance. The application may independently determine the importance of the components of the high bandwidth version. The web-design application may remove one or more components from the high bandwidth version of the web page and/or optimize one or more of the remaining components to generate the one or more lower bandwidth versions. Web service 120 may select and retrieve one of the higher bandwidth version or the lower bandwidth versions of the web page when a browser request specifies the web page.

As further shown in FIG. 6, the requested page may be modified (block 650). For example, after retrieving the version of the requested page, web service 120 may modify the version of the request page by adding and/or removing contents from the version based on the relevant estimate of available bandwidth. The code for the version may include priority information to identify one or more components of the version as optional, assign priority levels to the components (e.g., assign a value based on a scale of 1-10), and/or include size information of the components. The following are examples of HTML tags, for an image component (e.g., “large_image.jpg”) of a web page, with priority information:

<bwadjust optional=true priority=10><img src=“large_image.jpg”></bwadjust>.

Web service 120 may dynamically modify the requested page (e.g., determine which contents to include/exclude from the requested page) based on the priority information and/or predefined rules. For example, the predefined rules may include a rule to first remove Flash components, then to remove videos, then to remove images that are larger than a predefined size, etc. In another example, the predefined rules may include a rule to remove ads only after removing all non-text based components. In another implementation, web service 120 may determine a (predefined) maximum size based on the relevant estimate of available bandwidth. Web service 120 may remove components/contents from the requested page as long as a size of the requested page is greater than the maximum size. Web service 120 may only transmit, to web browser 110, contents that are not removed from the requested page.

Contents may be compressed and/or modified (block 660). For example, web service 120 may only provide a single version of the requested page. Web service 120 may compress and/or modify contents of the requested page before transmitting the contents of the requested page to web browser 110. In another example, web service 120 may compress and/or modify contents of the requested page after retrieving a version of the requested page (block 640) and/or modifying the requested page (block 650). In one implementation, web service 120 may compress one or more contents of the requested page, by using different quality settings, based on the relevant estimate of available bandwidth. For example, web service 120 may compress image contents by using JPEG compression, compress audio and video contents by using a different codec, etc. In another implementation, web service 120 may modify the components, based on the relevant estimate of available bandwidth, by retrieving pre-compressed versions of the contents and replacing the uncompressed contents with the compressed contents.

The contents for the requested page may be transmitted (block 670). For example, process 600 may include retrieving a version of the requested page, modifying the requested page, and/or compressing/modifying contents of the requested page. Thereafter, web service 120 may store/organize contents associated with the requested page in a queue based on a predefined order. For example, the predefined order may specify that web service 120 should transmit contents in an order based on types of the contents (e.g., the predefined order may specify to transmit text-based contents first, followed by image contents, followed by audio contents, followed by video contents, etc.). In another example, the predefined order may specify that web service 120 should transmit contents in an order based on size(s) of the contents (e.g., the predefined order may specify to transmit contents in order of its size, by transmitting the smallest-sized contents first and the largest-sized contents last). In yet another example, the predefined order may specify that web service 120 should transmit contents in an order based on priority levels associated with the contents. Web service 120 may transmit the contents, one-by-one, from of the queue to web browser 110. As further described below, the contents, that are organized to be transmitted in the queue, may change based on later updated estimates of available bandwidth.

An updated estimate of available bandwidth may be determined (block 680). In one implementation, web service 120 may determine the updated estimate of available bandwidth after receiving a new browser request from web browser 110. The new browser request may include bandwidth information. Web service 120 may use one or more of the algorithms described above, in reference to block 630, to determine the updated estimate of available bandwidth for the current browser request based on the new browser request. In another implementation, web browser 110 may independently calculate and transmit the updated estimate of available bandwidth based on the download/upload of the contents for the requested page. In yet another implementation, web service 120 may determine the updated estimate of available bandwidth based on Transmission Control Protocol (TCP)/IP acknowledgment packets (TCP/IP ACK, TCP/IP SACK, etc.), which are sent by client 210 to server 220, or vice versa, in response to packets based on contents for the requested page, received from web service 120.

After determining the updated estimate of available bandwidth, web service 120 may determine whether a significant change occurred in between the prior relevant estimate of available bandwidth and the updated estimate of available bandwidth. For example, web service 120 may that the significant change occurred when the difference between the prior relevant estimate of available bandwidth and the updated estimate of available bandwidth is greater than a predefined threshold, when the updated estimate of available bandwidth corresponds to a different type of connection from a type of connection associated with the prior relevant estimate of available bandwidth, etc. If the significant change occurred, web service 120 may determine whether web service 120 may change the contents of the queue associated with the requested page. If so, web service 120 may update the queue, based on the updated estimate of available bandwidth, by removing from and/or adding contents to the queue (block 650) and/or compressing and/or modifying contents in the queue (block 660). Web service 120 may continue to transmit the contents for the requested page based on the updated queue. In other words, web service 120 may commence transmission of the contents modified based on the updated estimate of available bandwidth instead of transmitting contents that were previously in the queue. The process for determining the updated estimate of available bandwidth may repeat until all of the contents for the requested page are downloaded.

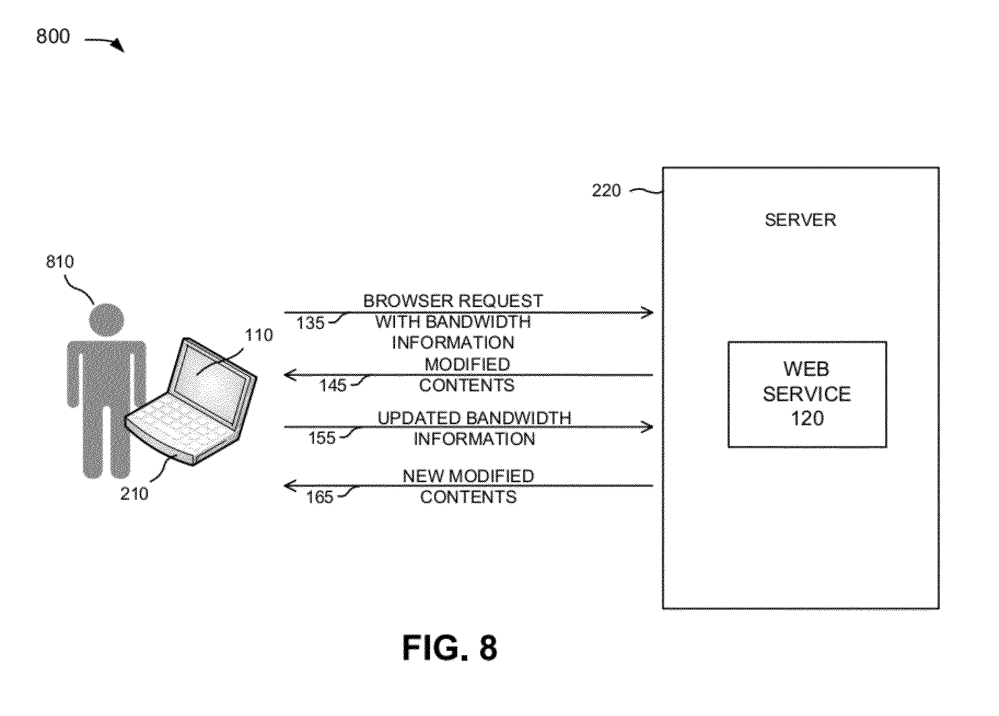

FIG. 8 is a diagram that illustrates an example 800 of providing tailored content based on available bandwidth to a user 810. User 810 may use client 210. User 810 may use client 210 to open a window of browser 110 in a display of client 210. Assume that user 810 enters input into browser 110 to download video contents, Example Video, from web service 120. Browser 110 may determine an estimate of available bandwidth for the opened window (i.e., a page load) that will display the downloaded video contents. Assume that client 210 connects to the Internet via a mobile broadband adapter. Accordingly, browser 110 may determine, for the estimate of available bandwidth, a low bandwidth (e.g., 0.1 Mbps). Browser 110 may generate browser request 135. Browser 110 may specify a location of the video contents (i.e., web service 120) and the estimate of available bandwidth. Browser 110 may transmit browser request 135 to web service 120.

Web service 120 may receive browser request 135. Based on browser request 135, web service 120 may determine that user 810, of client 210, requested to download the Example Video. Web service 120 may further determine that the estimate of available bandwidth, in browser request 135, indicates low bandwidth for client 210/browser 110. Accordingly, web service 120 may proceed to tailor video contents to provide the smallest possible size for the video contents. In one implementation, web service 120 may retrieve the video contents for the Example Video. Thereafter, web service 120 may compress the video contents to a lowest possible resolution to produce compressed video contents for Example Video. In another implementation, web service 120 may retrieve, from storage, the compressed video contents for Example Video, which was previously compressed.

Web service 120 may stream (e.g., by sending packets of) the compressed video contents, as modified contents 145, to browser 110. Browser 110 may display the Example Video based on the compressed video contents to user 810. User 810 may experience the Example Video in low resolution but without significant interruptions that would be required to obtain larger sized contents for the Example Video.

Assume that halfway through the video, user 810 connects client 210 to the Internet via a high-bandwidth WiFi connection. Browser 110 may transmit updated bandwidth information 155 to web service 120. Updated bandwidth information 155 may indicate that an updated estimate of available bandwidth for client 210/browser 110 is now much greater than the previous estimate of available bandwidth. Web service 120 may tailor (by producing and/or retrieving) new video contents based on the updated estimate of available bandwidth. Accordingly, the new video contents may have a higher resolution than the compressed video contents. Web service 120 may switch from streaming the compressed video contents to streaming the new video contents, as new modified contents 165, to browser 110. Browser 110 may now continue to display the Example Video based on the new video contents, instead of the compressed video contents, to user 810. User 810 may now experience the rest of the Example Video in high resolution instead of low resolution.

### CONCLUSION

The foregoing description provides illustration and description, but is not intended to be exhaustive or to limit the invention to the precise form disclosed. Modifications and variations are possible in light of the above teachings or may be acquired from practice of the invention.

For example, while series of blocks have been described with regard to FIGS. 4-6, the order of the blocks may be modified in other implementations. Further, non-dependent blocks may be performed in parallel. In addition, other blocks may be provided, or blocks may be eliminated, from the described flowcharts, and other components may be added to, or removed from, the described systems.

Also, certain portions of the implementations have been described as a “component” that performs one or more functions. The terms “component” may include hardware, such as a processor, an ASIC (application-specific integrated circuit), or an FPGA (field programmable gate array), or a combination of hardware and software (e.g., software running on a general purpose processor—creating a specific purpose processor).

It will be apparent that aspects described herein may be implemented in many different forms of software, firmware, and hardware in the implementations illustrated in the figures. The actual software code or specialized control hardware used to implement aspects does not limit the embodiments. Thus, the operation and behavior of the aspects were described without reference to the specific software code—it being understood that software and control hardware can be designed to implement the aspects based on the description herein.

Further, while reference has been made herein to web browsers and web pages, the description is not limited and may equally apply to other types of browsers and other types of documents. A “document,” as the term is used herein, is to be broadly interpreted to include any machine-readable and machine-storable work product. A document may include, for example, an e-mail, a web page or a web site, a file, a combination of files, one or more files with embedded links to other files, a news group posting, a news article, a blog, a business listing, an electronic version of printed text, a web advertisement, etc. Documents often include textual information and may include embedded information (such as meta information, images, hyperlinks, etc.) and/or embedded instructions (such as Javascript, etc.). A “link,” as the term is used herein, is to be broadly interpreted to include any reference to/from a document from/to another document or another part of the same document.

It should be emphasized that the term “comprises/comprising,” when used in this specification, is taken to specify the presence of stated features, integers, steps, or components, but does not preclude the presence or addition of one or more other features, integers, steps, components, or groups thereof

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method comprising:
receiving, by a client device, input for a browser;
determining, by the client device, an estimate of available bandwidth for the input;
generating, by the client device, a browser request based on the input and the estimate of available bandwidth;
transmitting, by the client device, the browser request to a server device;
receiving, by the client device and in response to the browser request, modified contents from the server device, where the modified contents are based on the estimate of available bandwidth; and
presenting, by the client device, the modified contents in a user interface of the browser.

2. The method of claim 1,
where the input comprises a Uniform Resource Identifier (URI) of a website,
where the browser request comprises a request for a web page of the website, and
where the modified contents comprises one of a plurality versions of the web page.

3. The method of claim 1, where determining the estimate of available bandwidth comprises:
calculating an estimate of total available bandwidth,
determining a quantity of page loads, where one of the page loads corresponds to the input, and
allocating a part of the estimate of total available bandwidth to the estimate of available bandwidth based on the quantity of page loads.

4. The method of claim 1, where determining the estimate of available bandwidth comprises:
receiving connection information of the client device, where the connection information comprises at least one or more of a type of a network connection of the client device to a network, a status of the network connection, or an IP address associated with the client device, and
calculating the estimate of available bandwidth based on at least one of the connection information or prior use information, where the prior use information comprises information about a previous connection by the client device to the server device via the network connection.

5. The method of claim 1, where determining the estimate of available bandwidth comprises:
downloading a test file for a speed test,
measuring one or more statistics related to the downloading of the test file, and
calculating the estimate of available bandwidth based on the one or more statistics.

6. The method of claim 1, further comprising:
determining an updated estimate of available bandwidth;
transmitting the updated estimate of available bandwidth to the server device;
receiving newly modified contents, instead of the modified contents, from the server device, where the newly modified contents are based on the updated estimate of available bandwidth and differ from the modified contents; and
presenting the newly modified contents in the user interface with or instead of the previously displayed modified contents.

7. A method comprising:
receiving, by a server device, a browser request from a client device;
identifying, by the server device, a web page specified by the browser request;
determining, by the server device, an estimate of available bandwidth based on the browser request;
tailoring, by the server device, the web page based on the estimate of available bandwidth; and
transmitting, by the server device, contents associated with the tailored web page to the client device.

8. The method of claim 7, where determining the estimate of available bandwidth comprises:
determining a purpose of the web page,
selecting bandwidth information from the browser request based on the purpose, and
using the bandwidth information to determine the estimate of available bandwidth.

9. The method of claim 7, where determining the estimate of available bandwidth comprises:
determining an Internet Protocol (IP) address associated with the client device based on the browser request,
retrieving connection information associated with the client device based on the IP address, where the connection information comprises at least one or more of a type of a network connection of the client device to a network, information regarding an Internet Service Provider (ISP) of the client device, a geographic location of the client, or information about a previous connection associated with the IP address, and
determining the estimate of available bandwidth based on the connection information.

10. The method of claim 7, where tailoring the web page comprises:
selecting a version of the web page based on the estimate of available bandwidth; and
modifying the version of the web page to produce the contents.

11. The method of claim 10, where modifying the version of the web page comprises:
determining a predefined maximum size based on the estimate of available bandwidth,
removing components from the version of the web page when a size of the version of the web page is greater than the predefined maximum size, and
compressing one or more of the contents that remain on the version of the web page after the removing of the components.

12. A device comprising:
a memory to store contents for a web page; and
a processor to:
determine an estimate of available bandwidth for a page load for the web page,
select one or more of the contents for the page load in response to a browser request from a browser,
modify the selected contents based on the estimate of available bandwidth to produce modified contents of the web page, and
transmit a part of the modified contents to the browser.

13. The device of claim 12, where the processor is further to:
determine an updated estimate of available bandwidth for the browser,
modify one or more of the selected contents based on the updated estimate of available bandwidth to produce other modified contents, and
transmit the other modified contents, instead of the modified contents, to the browser.

14. The device of claim 12, where, when modifying the selected contents, the processor is further to:
retrieve pre-compressed versions of one or more of the selected contents, and
replace the one or more of the selected contents with the pre-compressed versions,
where the modified contents comprise the pre-compressed versions, and
where the pre-compressed versions comprise at least one or more of compressed video contents, compressed audio contents, or compressed image contents that were created before the selecting of the one or more of the contents.

15. The device of claim 12, where, when determining the estimate of available bandwidth, the processor is further to:
determine a type of a network connection associated with the browser, and
determine the estimate of available bandwidth based on the type of the network connection.

16. A computer-readable medium containing instructions executable by at least one processor, the computer-readable medium comprising instructions to:
receive a browser request from a web browser, where the browser request identifies a web page of a website;
determine an estimate of available bandwidth, for the web page, based on the browser request;
retrieve a version of the web page based on the estimate of available bandwidth; and
transmit packets, based on contents of the version of the page, to the web browser.

17. The computer-readable medium of claim 16, further comprising instructions to:
modify the version of the web page based on the estimate of available bandwidth; and
replace a part of original contents in the version with compressed contents based on the estimate of available bandwidth.

18. The computer-readable medium of claim 16, further comprising instructions to:
receive one or more messages in response to one or more of the packets;
determine an updated estimate of available bandwidth based on the receipt of the one or more messages;
modify a part of the contents based on the updated estimate of available bandwidth;
generate new modified packets based on the part of the contents; and
transmit the new modified packets to the web browser.

19. The computer-readable medium of claim 16, where the instructions to determine the estimate of available bandwidth comprise instructions to:
determine a predicted user action based on the web page; and
select the estimate of available bandwidth from the browser request that is associated with a type of the predicted user action, where the estimate of available bandwidth is one of an estimate of download bandwidth or an estimate of upload bandwidth.

20. The computer-readable medium of claim 16,
where the version of the web page is a high bandwidth version when the estimate of available bandwidth is above a first threshold,
where the version of the web page is a low bandwidth version when the estimate of available bandwidth is below a second threshold, or
where the version of the web page is a medium bandwidth version when the estimate of available bandwidth is below the first threshold and above the second threshold.
